(19) United States
(12) Patent Application Publication
(10) Pub. No.: US 2006/0095573 A1
(43) Pub. Date: May 4, 2006

(54) Delayed HTTP response

(75) Inventors: Kevin T. Carle, Mountain View, CA (US); Dustin L. Green, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/978,875

(22) Filed: Nov. 1, 2004

(51) Int. Cl. G06F 15/16

(52) U.S. Cl. 709/227

(57) ABSTRACT

Delayed HTTP response is described. In an embodiment, a server device receives a data connection request from a client device and opens a data connection to establish an HTTP communication link to the client device. A first message can be communicated to the client device via the HTTP communication link when the message becomes available. After the first message is returned, the HTTP communication link to the client device is maintained open for communication such that the server device can communicate additional messages to the client device when the additional messages become available at the server device. The messages need not exist or be created at the time of an initial client HTTP request.

### TECHNICAL FIELD

This invention relates to delayed HTTP response.

### BACKGROUND

In a typical client-server system, the server device and the client device are separated from one another by a firewall, such as a common residential firewall implemented at the client device for home delivery of high-speed Internet access. Firewalls restrict the ability of computing devices on opposite sides of the firewall to communicate data packets to one another, and also restrict the ability of the computing devices on opposite sides of the firewall to open reliable network connections to one another, such as a TCP (Transmission Control Protocol) connection. Often, applications on the client side of a firewall are able to do little more than open an HTTP (Hypertext Transfer Protocol) connection to a server device and receive a data response. A client-side firewall also restricts a server device from initiating a network connection to the client device.

In addition to the constraints that a firewall poses to opening a network connection to a client device, opening a network connection through a firewall exposes a port of the client device for TCP communications and allows another computer system to connect and transmit malicious code or data, and generally places the client device at risk for a variety of attacks. Even if the code handling connections for the port of the client device eliminates security holes that may lead to a system crash or data corruption, the system is still susceptible to denial of service attacks where an attacker simply floods the connection with so many requests-that the client device is no longer able to function properly.

The limited communication constraints and the desire to avoid open socket connections on a client device make it difficult to communicate data from a server device where the data is initiated for communication by the server device. If the client device has not initiated a network connection to the server device, the server is unable to send data to the client device. A solution for this problem is to have client device(s) periodically initiate an HTTP connection to the server and either receive data that is pending at the server, or receive an indication that no data is currently pending. The HTTP connection is then immediately closed after a client device receives the pending data or the indication that no data is pending.

There are several disadvantages to this technique of having client devices continuously “polling” the server when data may or may not be available. The client devices will be opening and closing network connections to the server on an ongoing basis, regardless of whether any data is actually available. In addition, when the response time between a connection request at the server and delivery of a message to a client must be below some predetermined duration, the polling interval for each client device must also be less time than the predetermined duration which does not scale when there are many client devices connecting to the server. The overhead associated with creating a new HTTP/TCP connection is substantially larger than the overhead associated with transmitting the data once a connection has been established.

Accordingly, there is need to provide a communication system that allows a server device to initiate HTTP data communication to client device(s) without a client device requesting the data from the server, and without opening and exposing an HTTP port of the client device to potential computing device attacks.

### SUMMARY

Delayed HTTP Response is described herein.

In an implementation of delayed HTTP response, a server device receives a data connection request from a client device and establishes an HTTP communication link to the client device. A server application generates a message response that can be returned to the client device as a first message via the HTTP communication link when the message becomes available. After the message response is returned, the HTTP communication link to the client device is maintained for open communication such that the server device can communicate additional messages to the client device when the additional messages become available at the server device.

In another implementation of delayed HTTP response, a server device receives a TCP connection request and an HTTP request from a client device, and the server device responds to the TCP connection request by opening a socket connection to establish an HTTP communication link to the client device. The server device then delays the response to the HTTP request until the server device has a message to send to the client device, or until an optional predetermined timeout expires. A server application can generate a message at any time that can be returned to the client device via the HTTP communication link when the message becomes available. After the message is returned, the client device generates a second HTTP request and the socket connection to the client device is maintained such that the server device can communicate an additional message to the client device in response to the second HTTP request via the open HTTP communication link when the additional message becomes available.

### BRIEF DESCRIPTION OF THE DRAWINGS

The same numbers are used throughout the drawings to reference like features and components.

FIG. 1 illustrates an exemplary client-server system in which an embodiment of delayed HTTP response can be implemented.

FIG. 2 is a flow diagram that illustrates an exemplary method for delayed HTTP response and is described with reference to a server device in the exemplary client-server system shown in FIG. 1.

FIG. 3 is a flow diagram that illustrates an exemplary method for delayed HTTP response and is described with reference to a client device in the exemplary client-server system shown in FIG. 1.

FIG. 4 is a flow diagram that illustrates an exemplary method for delayed HTTP response and is described with reference to a server device in the exemplary client-server system shown in FIG. 1.

FIG. 5 is a flow diagram that illustrates an exemplary method for delayed HTTP response and is described with reference to a client device in the exemplary client-server system shown in FIG. 1.

FIG. 6 illustrates various components of an exemplary computing device that can be implemented as client and/or server device in the exemplary client-server system shown in FIG. 1 for delayed HTTP response.

FIG. 7 illustrates an exemplary television-based system and is an example of the client-server system shown in FIG. 1 in which an embodiment of delayed HTTP response can be implemented.

### DETAILED DESCRIPTION

Delayed HTTP response allows a server device to communicate data (e.g., as messages) to client device(s) via an HTTP communication link without opening and exposing a TCP or a UDP port of a client device to potential computing device attacks. The server device and the client device maintain a data connection such that the server can communicate more than one complete data message to the client device via the open HTTP communication link through a firewall implemented by the client device or interposed between the server and the client device.

While aspects of the described systems and methods for delayed HTTP response can be implemented in any number of different computing systems, environments, and/or configurations, embodiments of delayed HTTP response are described in the context of the following exemplary system architecture.

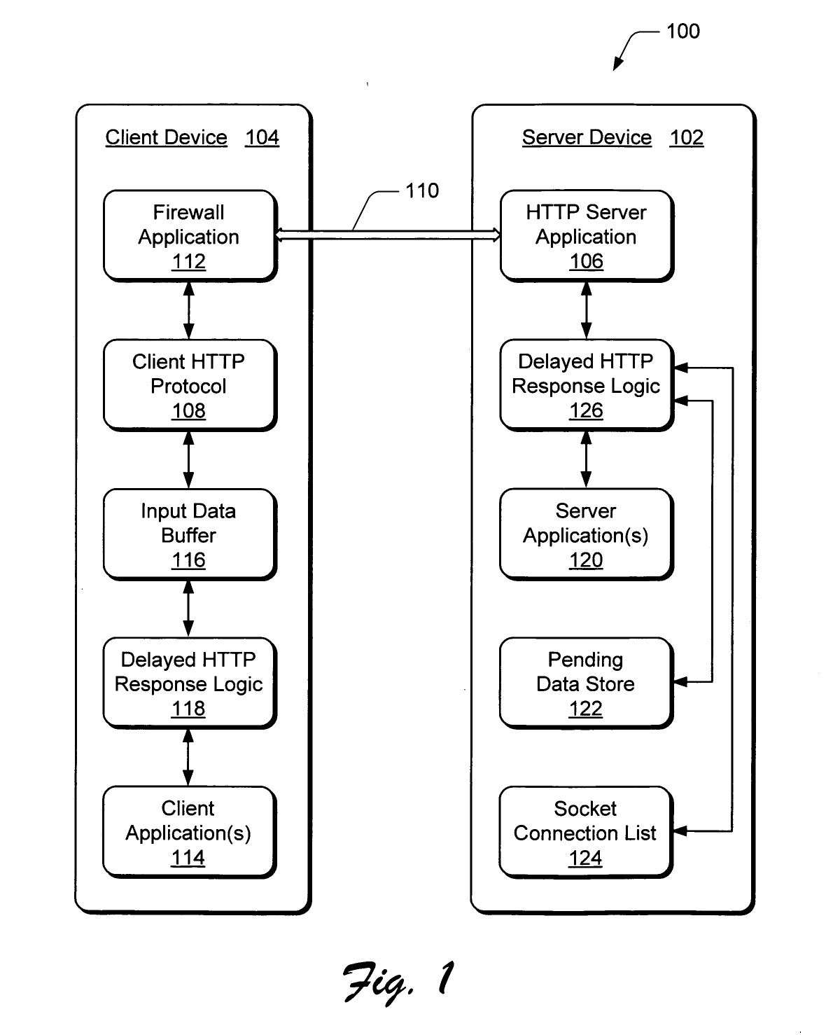

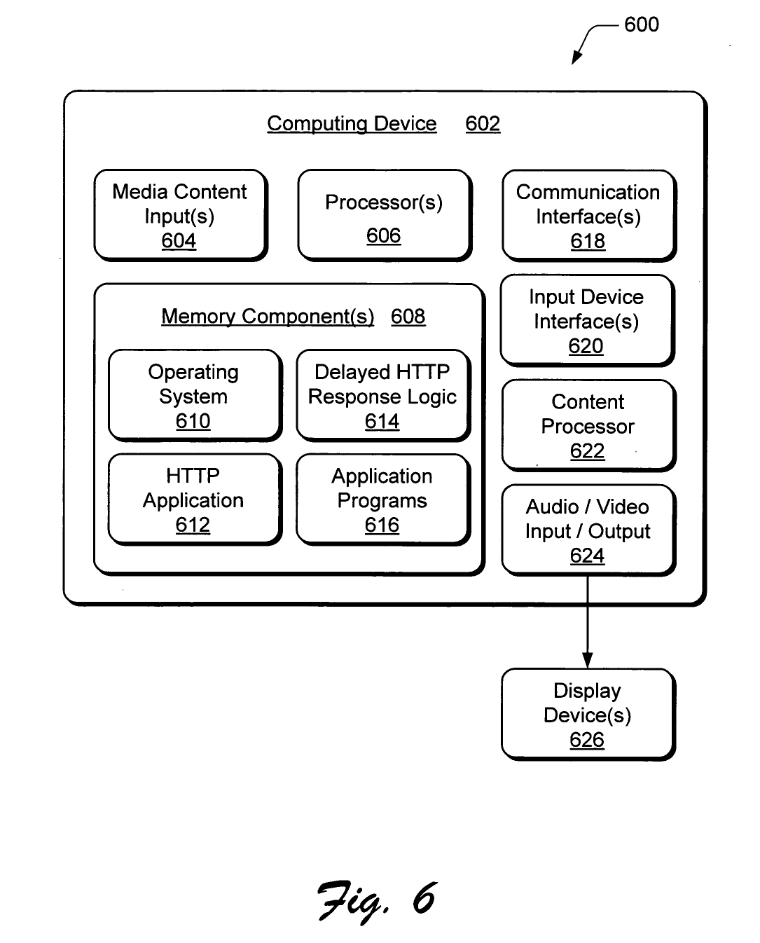

FIG. 1 illustrates an exemplary client-server system 100 in which an embodiment of delayed HTTP response can be implemented. The client-server system 100 includes a server device 102 and a client device 104. Although only one client device 104 is shown, the client-server system 100 may include any number of client devices configured for communication with server device 102. Further, a client and/or server device may be implemented as any form of computing or electronic device with any number and combination of differing components as described below with reference to the computing device 602 shown in FIG. 6.

Server device 102 includes an HTTP server application 106 that accepts a socket connection for communication with client device 104. Similarly, client device 104 includes client-side HTTP protocol 108 that opens a socket connection for the client device such that an HTTP communication link 110 is established between the client device 104 and the server device 102 for data communication. In this example, the HTTP server application 106 and the client-side HTTP protocol 108 are representative of a typical HTTP server-client system, and delayed HTTP response as described herein can be implemented with any standard HTTP server-client protocol or system.

There is currently an HTTP/1.0 protocol and an HTTP/1.1 protocol. For HTTP/1.0 communications, a client device opens a socket connection and communicates a TCP connection request and an HTTP request to a server device. The server device accepts the socket connection for communication and responds by sending an HTTP response (e.g., a data message) to the client device, and then closes the underlying TCP connection. In an embodiment of delayed HTTP response, the underlying TCP connection is not closed after the server device completes sending a message to the client device. The TCP connection is maintained for open communication such that the server device can communicate additional message(s) to the client device without the client device having requested the additional message(s). For the HTTP/1.0 protocol, the messages communicated to a client device are all part of an ongoing HTTP/1.0 response.

For HTTP/1.1 communications, the server device can respond to an HTTP request from a client device with different types of responses, such as a complete response or a chunked response. When the server device communicates a chunked HTTP/1.1 response to the client device, the server device sends a length indicator corresponding to a portion of the HTTP response (rather than the length of the complete response) to the client device and then sends that portion, or chunk, of the HTTP response to the client device. The server device can then send more length indicators preceding more chunks of the response to the client device, or the server device can indicate an end of the HTTP response. The underlying TCP connection is left open while the server device sends the additional length indicators and chunks of the response to the client device.

In an embodiment of delayed HTTP response, the underlying TCP connection is not closed after the server device completes sending a message to the client device. The TCP connection is maintained for open communication such that the server device can communicate additional message(s) to the client device without the client device having requested the additional message(s). Each message sent to a client device may be separated into chunks in an arbitrary manner. A message may be split across chunks, and a chunk may contain portions of one or more messages or message headers. For the HTTP/1.1 protocol, the messages communicated to a client device are all part of an ongoing HTTP/1.1 chunked response.

When the server device communicates a complete HTTP/1.1 response (i.e., a non-chunked response) to the client device, the server device first sends a length indicator of the complete HTTP response to the client device before sending the data response itself. The underlying TCP connection is left open such that if the client device initiates an additional HTTP request to the server device, the server device can then communicate another HTTP response via the same underlying TCP connection. In an embodiment of delayed HTTP response, the client device initiates another HTTP request to the server device just after receiving an HTTP/1.1 response. Rather than immediately responding to the additional HTTP request as would be expected with a typical HTTP server-client system, the server device can delay any response to the HTTP request until the server device has a message available to send to the client device, or until an optional predetermined timeout expires.

In the embodiments of delayed HTTP response, an HTTP protocol is being “pushed forward” to a point where the client device can idly wait for a response from the server device, rather than having the server device idly wait for a request from the client device. With a typical HTTP server-client system, the server device has to wait until the client device initiates a request so that the server device can communicate the pending message to the client device. With delayed HTTP response as described herein, the server device does not have to wait for a client request, but can simply communicate the pending message as a “response” to the idle client device whenever the server device has the message ready for communication. The timing of the HTTP protocol is being reversed to facilitate server-controlled data communication to a client device without impacting the designated client and server functions of an HTTP server-client protocol.

The exemplary client-server system 100 includes a firewall application 112, which in this example, is shown as a component of client device 104. In an alternate embodiment, firewall application 112 (or firewall applications) may be interposed between the server device 102 and the client device 104 as an independent component of the client-server system 100 or as a component of a separate computing device. The firewall application 112 restricts open communication for other than HTTP communications with client device 104. The firewall application 112 can be implemented as one or more related applications to protect the system of client device 104 and to prevent and/or control the extent of access from external sources. In the exemplary client-server system 100, the HTTP communication link 110 connects through the firewall application 112 in client device 104.

The client device 104 also includes any number of different client-side applications 114, such as a television-based programming guide application, a Web browser that requests a Web page or other data from server device 102, and/or any number of other applications that may be implemented on a client device in a network environment. A client application 114 can request data from the server device 102, and/or communicate a generic URL such as “next message command” to the server device 102, to initiate establishing the HTTP communication link 110 through firewall application 112. Rather than immediately responding with a positive or negative response to the communication request from the client device 104, the server device 102 can maintain the HTTP communication link 110 open for server-controlled data communication, as described above.

When the server device 102 has a message response or pending message(s) for client device 104, the server device 102 can communicate a message to the client device 104 via the open HTTP communication link 110 to complete the second half of the HTTP protocol. However, the server device 102 does not communicate an indication to the client device 104 that the message is a completed HTTP response by closing the socket connection. Rather, the a message can include identifier(s) to distinguish one complete message from another. As an alternative to identifiers or specific delimiters that encapsulate messages, a message can itself be structured such that message boundaries are implicitly clear, such as with XML or HTML data formats.

The client device 104 can continue to receive additional data (e.g., complete messages) over the same underlying TCP connection as long as both the server device 102 and the client device 104 remain on-line and a networking failure does not intervene. The client device 104 determines a complete message from the data identifier(s) which may include some form of a token, such as a length tag at the beginning of a data message, or any implementation of a tokenized message that can be parsed and recognized by the client device 104.

The client device 104 includes an input data buffer 116 to store incoming data received from the server device 102 via the HTTP communication link 110. When client device 104 receives a message in response to an HTTP request, the client device 104 stores the message in the input data buffer 116 and then continues to read from the socket connection for additional incoming data and messages.

Client device 104 includes an embodiment of delayed HTTP response logic 118 that maintains the socket connection (e.g., the underlying TCP connection) to server device 102 after a message response is received such that the client device 104 can receive additional messages from the server device 102 via the open HTTP communication link 110. Thus, network connections are only created and closed when client device(s) connect to or disconnect from the server device 102, and the server device 102 does not have to continually open and close network connections to satisfy polling requirements for multiple client devices.

The server device 102 includes any number of different server-side applications 120 that may be implemented on a server device in a network environment. The server device 102 also includes a pending data store 122, a socket connection list 124, and an embodiment of delayed HTTP response logic 126. The server device 102 stores data (e.g., as messages) for client device 104 in the pending data store 122 before the HTTP communication link 110 is established between the client device 104 and the server device 102. When the HTTP communication link 110 is established, the server device 102 can then communicate the pending data and/or message(s) stored in the pending data store 122 to the client device 104. Although shown as a separate component of the server device 102, the delayed HTTP response logic 126 can be implemented as a component of the HTTP server application 106.

When the HTTP communication link 110 is established between the client device 104 and the server device 102, the server device can add an identifier of the socket connection for the HTTP communication link 110 associated with the client device 104 to the socket connection list 124. Similarly, when the HTTP communication link 110 is disconnected and the socket connection is closed, the server device 102 can remove the identifier of the socket connection from the socket connection list 124.

The delayed HTTP response logic 126 in server device 102 maintains the TCP connection for the HTTP communication link 110 to the client device 104 after a message response has been returned to the client device 104 such that the server device 102 can communicate additional data, such as a second message, to the client device 104 via the open HTTP communication link 110. In the embodiments of delayed HTTP response described above with reference to HTTP/1.0 communications and chunked HTTP/1.1 communications, the additional data of the second message can be communicated by the server device 102 to the client device 104 without having received a second request for the additional data from the client device 104. In the embodiment of delayed HTTP response described above with reference to complete HTTP/1.1 responses (i.e., non-chunked responses), the additional data of the second message can be communicated to the client device 104 after having received a second request from the client device 104 to facilitate server-controlled (or “server-timing-controlled”) data communication. Any subsequent requests from the client device 104 may also specify which messages have been successfully received from the server device 102.

The client-side delayed HTTP response logic 118 and the server-side delayed HTTP response logic 126 are configured to implement delayed HTTP response without constraints on message content, message length, or other data communication variables in a typical HTTP server-client implementation, such as with the HTTP server application 106 and the client-side HTTP protocol 108. Delayed HTTP response is applicable for any type of data within any system when a server device can communicate messages to one or more client devices via an open communication link through a client device firewall without additional requests for the messages from the client device (e.g., as with HTTP/1.0 communications and chunked HTTP/1.1 communications).

The client device 104 is protected from access by external sources because the client device 104 initiates establishing the HTTP communication link 110 through firewall 112. However, the server device 102 can quickly communicate data and more than one complete message to client device 104 via the open HTTP communication link 110 without waiting for additional data requests from the client device 104 (as with HTTP/1.0 communications and chunked HTTP/1.1 communications), and while the client device 104 is idle waiting for a server-controlled data response (as with complete HTTP/1.1 communications). The client device need not “poll” the server with periodic HTTP requests in order to receive timely messages from the server. Rather than a client device having to often re-query the server in order to achieve timely reception of messages from the server, when there are no messages, there is no communication from the server device to the client device. As soon as a message is available for the client device, however, the server can immediately send it to the client device because the HTTP protocol has already been made ready to send data from the server to the client.

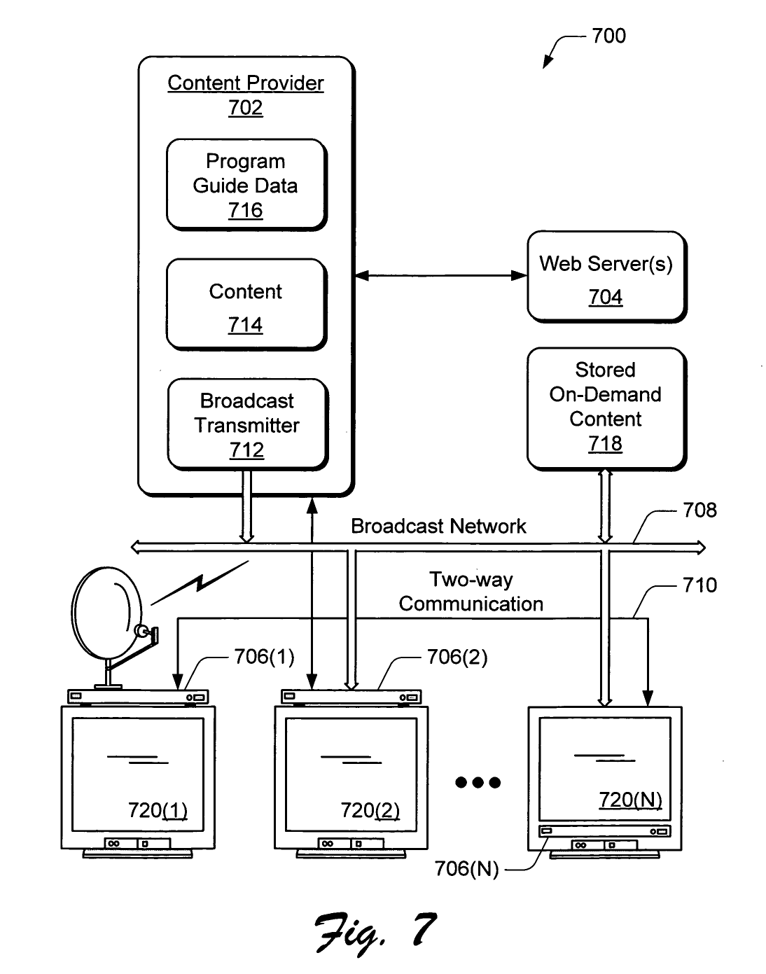

An example implementation of the client-server system 100 includes a television-based system 700 as described below with reference to FIG. 7. A television-based client device implemented as a digital video recorder is an example of client device 104 that can receive server-controlled, time-dependent messages from a content distribution system which is an example of server device 102. In a television-based system, a user may interact, or interface, with a television-based client device only intermittently, however a response by the distribution server may be time-sensitive to accommodate the user experience. The distribution server can communicate a record command and channel designator to the digital video recorder (e.g., client device 104) to tune and record a program that has been scheduled for recording. The message to record the program can be communicated via an open HTTP communication link that has been previously established between the television-based client device and the distribution server.

Similarly, the distribution server may communicate a programming alert to several television-based client devices, such as a message for user display that instructs a user to tune to a particular channel for local information. A programming alert may include an implementation of an emergency alert service for users of client devices in a local area that may be affected by a dangerous weather condition. The distribution server can also communicate an instruction that the client devices auto-tune to a particular programming channel to receive the emergency alert. A programming alert may also be a channel tune instruction to the client devices to adjust channel display logic to receive a particular version of commercials that should be broadcast during a program in a particular viewing area, such as to satisfy Canadian regulatory requirements when a U.S.-based program is being displayed for viewing, for example. The programming alert messages are time-sensitive and need to be communicated in a timely manner via open HTTP communication links that have been previously established between the distribution server and the respective television-based client devices.

Another example implementation of the client-server system 100 includes a caller-identifier system in which a server device communicates caller-id information to a client device for display so that a user can determine whether or not to take a call. Again, the timing of the message delivery is server-controlled such that the message can be communicated as-needed and when needed via an open HTTP communication link that has been previously established.

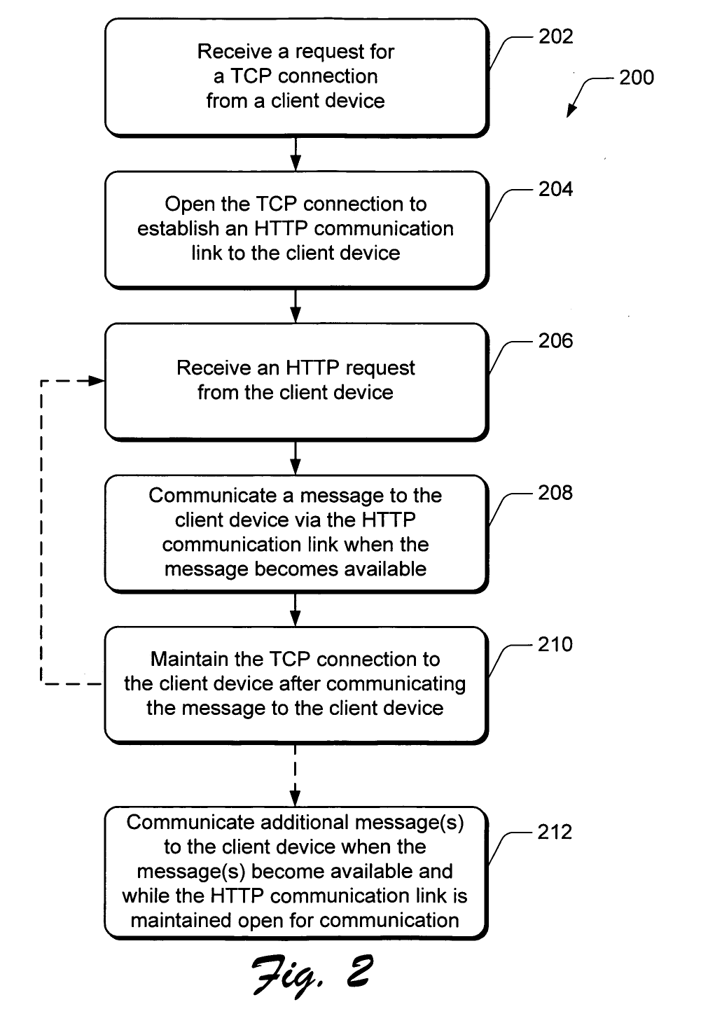

Methods for delayed HTTP response, such as exemplary methods 200-500 described with reference to respective FIGS. 2-5, may be described in the general context of computer executable instructions. Generally, computer executable instructions include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 2 illustrates an exemplary method 200 for delayed HTTP response and is described with reference to a server device in the exemplary client-server system shown in FIG. 1. The order in which the method is described is not intended to be construed as a limitation, and any number of the described method blocks can be combined in any order to implement the method. Furthermore, the method can be implemented in any suitable hardware, software, firmware, or combination thereof.

At block 202, an HTTP request for a TCP connection to establish a communication link is received from a client device. For example, server device 102 (FIG. 1) receives a TCP connection request from client device 104 to establish the HTTP communication link 110. At block 204, a TCP connection is opened to establish an HTTP communication link to the client device. For example, client HTTP protocol 108 in client device 104 opens a socket connection to a port on the server device 102 and the HTTP server application 106 in server device 102 accepts the socket connection to accommodate the TCP connection request from client device 104. The delayed HTTP response logic 126 in server device 102 maintains the HTTP communication link 110 open for continued data communication.

At block 206, an HTTP request is received from the client device. For example, server device 102 receives an HTTP request from client device 104. At block 208, a message is communicated as a response to the client device via the HTTP communication link when the message becomes available. For example, a server application 120 in server device 102 generates a message intended for client device 104 and the server device 102 communicates the message as a server-controlled response to the client device 104 via the open HTTP communication link 110. The client device 104 can communicate an HTTP request to the server device, and the server device 104 responds with server-initiated or server-controlled message(s), between which the client device 104 may sit idle waiting for a response.

Some of the messages may be “null” messages that are communicated to the client device 104 to keep the server and/or the client device from timing out and closing the underlying TCP connection. The server-controlled response need not exist or be created at the time the client device makes a request. In an embodiment of delayed HTTP response, the client device makes a request on speculation that a message for the client device will be created at some time in the future, and the server device waits until such a message for the client exists before sending a response to the client device.

At block 210, the TCP connection to the client device is maintained after communicating the message to the client device. For example, the delayed HTTP response logic 126 in server device 102 is implemented to maintain the HTTP communication link 110 open through the firewall 112 of client device 104 and without communicating an indication to the client device 104 that the TCP connection should close. At block 212, additional message(s) are communicated to the client device when they become available and while the HTTP communication link is maintained open for data communication.

For example, with HTTP/1.0 communications and chunked HTTP/1.1 communications, the server device 102 initiates additional messages for communication to the client device 104 without receiving a second request for the additional messages from the client device 104. The additional message(s) communicated to the client device 104 are server-controlled and communicated to the client device 104 when they become available at the server device 102. For complete HTTP/1.1 communications, the method 200 continues from block 210 to receive another HTTP request from the client device at block 206 just after the client device 104 receives the previous message communicated at block 208. Again, at block 208, a subsequent message is communicated to the client device via the HTTP communication link when an additional message becomes available at the server device.

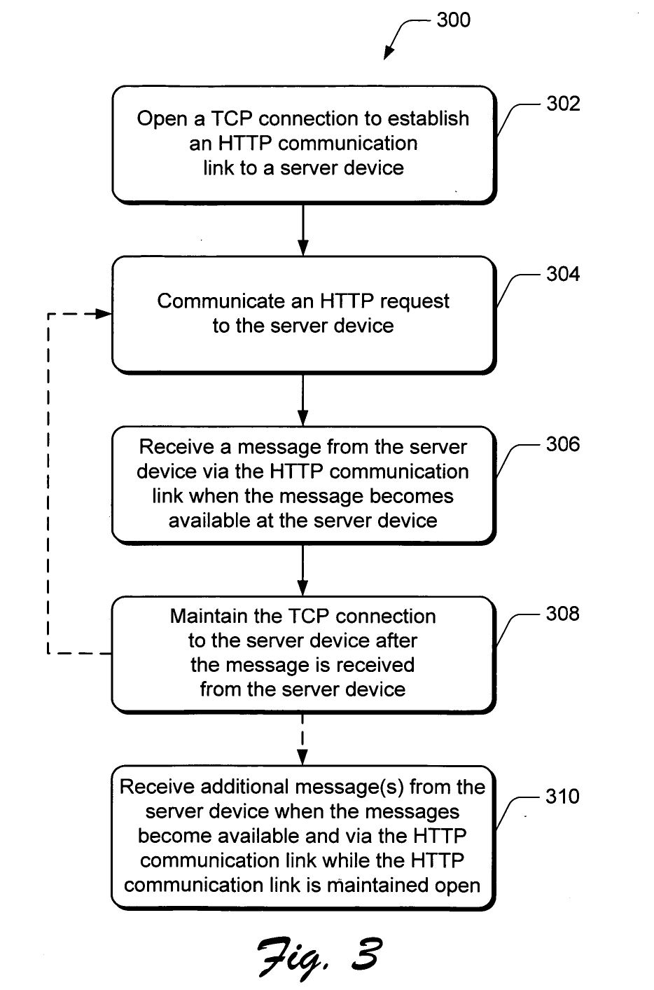

FIG. 3 illustrates an exemplary method 300 for delayed HTTP response and is described with reference to a client device in the exemplary client-server system shown in FIG. 1. The order in which the method is described is not intended to be construed as a limitation, and any number of the described method blocks can be combined in any order to implement the method. Furthermore, the method can be implemented in any suitable hardware, software, firmware, or combination thereof.

At block 302, a TCP connection is opened to establish an HTTP communication link to a server device. For example, client HTTP protocol 108 in client device 104 (FIG. 1) opens a socket connection to a port on the server device 102 and the HTTP server application 106 in server device 102 accepts the socket connection to accommodate a connection request to establish the HTTP communication link 110 to server device 102. At block 304, an HTTP request is communicated to the server device. For example, a client application 114 communicates an HTTP request to the server device 102, such as a request for data from a server application 120. At block 306, a message is received from the server device via the HTTP communication link when the message becomes available at the server device. For example, client device 104 receives a message from the server device 102 via the HTTP communication link 110.

At block 308, the TCP connection to the server device is maintained after the message is received. For example, the delayed HTTP response logic 118 in client device 104 maintains the HTTP communication link 110 open through the firewall 112 of the client device 104. At block 310, additional message(s) are received from the server device via the HTTP communication link while the HTTP communication link is maintained open. For example, with HTTP/1.0 communications and chunked HTTP/1.1 communications, client device 104 receives additional message(s) from the server device 102 that are not specifically requested by the client device 104, and when the messages become available at the server device 102. For complete HTTP/1.1 communications, the method 300 continues from block 308 to communicate another HTTP request to the server device at block 304. Again, at block 306, a message is received from the server device via the HTTP communication link when the message becomes available at the server device.

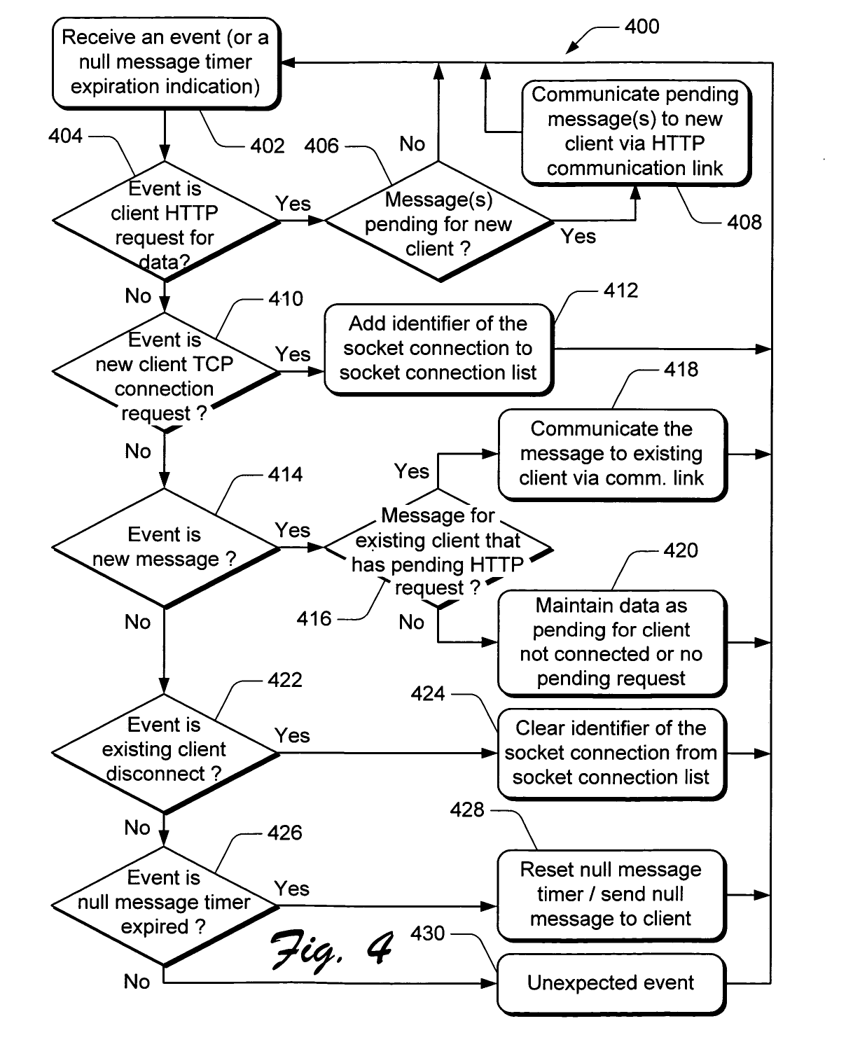

FIG. 4 illustrates an exemplary method 400 for delayed HTTP response and is described with reference to a server device in the exemplary client-server system shown in FIG. 1. The order in which the method is described is not intended to be construed as a limitation, any of the described method blocks may be optional in an implementation of delayed HTTP response, and any number of the described method blocks can be combined in any order to implement the method. Furthermore, the method can be implemented in any suitable hardware, software, firmware, or combination thereof.

At block 402, an event or an indication that a null message timer has expired is received at a server device. For example, the delayed HTTP response logic 126 in server device 102 (FIG. 1) receives an event from HTTP server application 106, from client device 104, or from another server that sends messages downstream. At block 404, a determination is made as to whether the received event is a client HTTP request for data. If the received event is a client HTTP request for data (i.e., “yes” from block 404), then a determination is made as to whether there are any messages pending for the new client that has initiated the HTTP request, at block 406.

If there are no message(s) pending for the new client (i.e., “no” from block 406), then the method returns to block 402 and the delayed response logic waits to receive a new event. If there are message(s) pending for the new client (i.e., “yes” from block 406), then at block 408, the pending message(s) are communicated to the new client via the HTTP communication link between the client device and the server device. For example, server device 102 communicates any pending messages stored in the pending data store 122 to the client device 104 via the HTTP communication link 110. The method then returns to block 402 and the delayed HTTP response logic 126 in server device 102 waits to receive a new event.

At block 410, a determination is made as to whether the received event is a new client TCP connection request. For example, server device 102 receives a TCP connection request to establish HTTP communication link 110 from client device 104. If the received event is a new client connection request (i.e., “yes” from block 410), then an identifier of the socket connection is added to the socket connection list at block 412. For example, server device 102 adds an identifier of the socket connection associated with client device 104 to the socket connection list 124.

If the received event (at block 402) is not a new client connection request (i.e., “no” from block 410), then a determination is made as to whether the event is a new message, at block 414. If the received event is a new message (i.e., “yes” from block 414), then, at block 416, a determination is made as to whether the new message is for one or more existing clients that have an associated HTTP communication link to the server device and that have an HTTP request pending. If the new message is for existing client(s) with an HTTP request pending (i.e., “yes” from block 416), then the message is communicated to the existing client(s) via the respective HTTP communication links between the client device(s) and the server device at block 418. Additionally, a null message timer is reset at block 418. For example, server device 102 determines whether a new or additional message is for client device 104 and communicates the new or additional message to client device 104 via the HTTP communication link 110.

If the new message is for client(s) that are not connected to the server device or that do not have an HTTP request pending (i.e., “no” from block 416), then the message is maintained as pending for the respective client(s) that are not connected or that do not have a pending request at block 420. For example, server device 102 stores the new message in the pending data store 122 for client devices that are not connected to the server device 102, or that do not have an HTTP request pending with the server device 102. For multiple client devices that communicate with a server, the new message at block 416 may be both for existing client(s) with an HTTP request pending (i.e., “yes” from block 416), and for client(s) that are not connected to the server device or that don't have an HTTP request pending (i.e., “no” from block 416). After the new message is communicated to the existing clients with a pending HTTP request at block 418, and/or after the message is maintained as pending for client(s) that are not connected or that do not have a pending request at block 420, the method returns to block 402 and the delayed response logic of the server device waits to receive a new event.

If the received event is not a new message (i.e., “no” from block 414), then, at block 422, a determination is made as to whether the event is an existing client disconnect, such as a client device closing a socket connection and an HTTP communication link to the server device. If the received event is an existing client disconnect (i.e., “yes” from block 422), then the identifier of the socket connection for the respective client is cleared from the socket connection list at block 424. For example, server device 102 clears the identifier of the socket connection associated with the client device 104 from the socket connection list 124. The method then returns to block 402 and the delayed response logic of the server device waits to receive a new event.

If the received event is not an existing client disconnect (i.e., “no” from block 422), then a determination is made as to whether the event is a null message timer expiration at block 426. If the received event is a null message timer expiration (i.e., “yes” from block 426), then the null message timer is reset and a null message is sent to the client device at block 428. For example, server device 102 communicates a null message to client device 104 to keep various modules or components of the client and/or server devices from assuming that the server has hung in processing a request. If the received event is not a null message timer expiration (i.e., “no” from block 426), then the event is unexpected at block 430 and the method again returns to block 402.

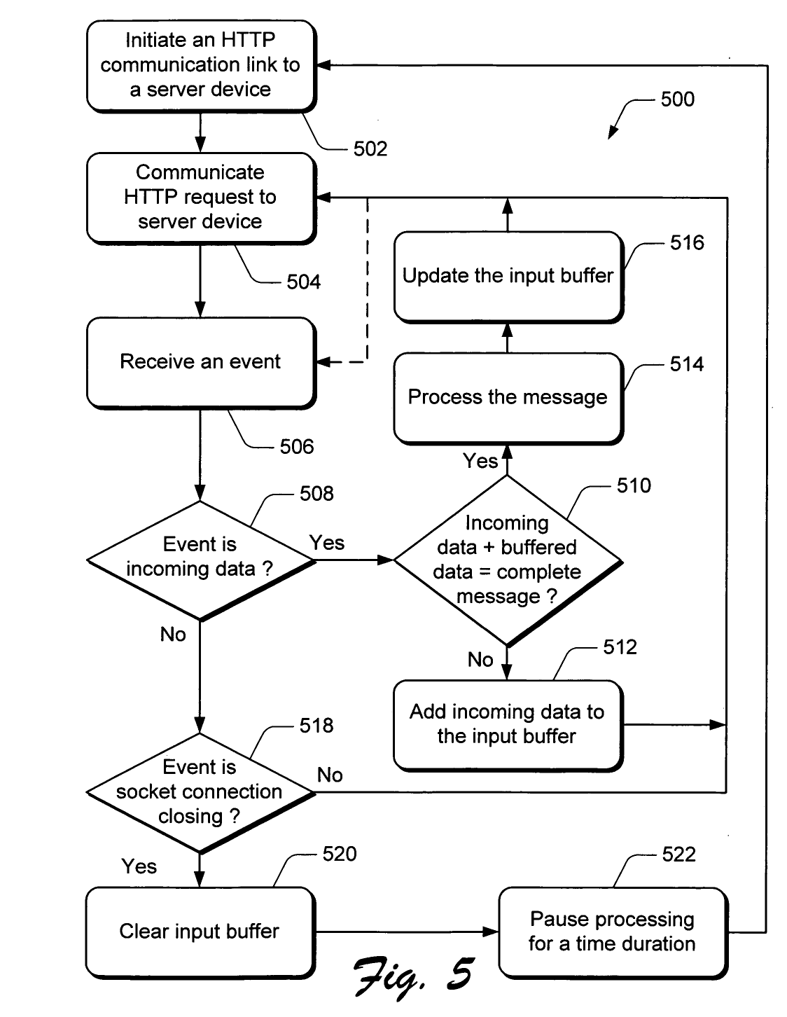

FIG. 5 illustrates an exemplary method 500 for delayed HTTP response and is described with reference to a client device in the exemplary client-server system shown in FIG. 1. The order in which the method is described is not intended to be construed as a limitation, any of the described method blocks may be optional in an implementation of delayed HTTP response, and any number of the described method blocks can be combined in any order to implement the method. Furthermore, the method can be implemented in any suitable hardware, software, firmware, or combination thereof.

At block 502, a client device initiates an HTTP communication link to a server device. For example, client device 104 (FIG. 1) communicates a data connection request to server device 102 and initiates the HTTP communication link 110 to server device 102. At block 504, an HTTP request is communicated to the server device. For example, client device 104 communicates an HTTP request to the server device 104.

At block 506, an event is received at the client device. At block 508, a determination is made as to whether the event is incoming data. If the event is incoming data (i.e., “yes” from block 508), then, at block 510, a determination is made as to whether the incoming data plus any data pending in an input buffer forms a complete message. For example, client device 104 receives data from server device 102 via HTTP communication link 110 and determines whether the incoming data plus data pending in the input data buffer 116 forms a complete message.

If the incoming data and the pending data does not form a complete message (i.e., “no” from block 510), then the incoming data is added to the input buffer at block 512. For example, the client device 104 adds the incoming data to input data buffer 116. The method then returns to block 504 or to block 506 and the client device waits to receive a new event. For HTTP/1.0 communications and for chunked HTTP/1.1 communications, the method 500 continues from block 506 and the client device waits idle to receive a new event. For complete HTTP/1.1 communications, the method 500 continues from block 504 to communicate another HTTP request to the server device, and then to block 506 where the client device waits to receive a new event.

If the incoming data together with the buffered data does form a complete message (i.e., “yes” from block 510), then the message is processed (to include discarding a null message) by the client device at block 514 and the input buffer is updated at block 516. For example, client device 104 either clears the input data buffer 116 to receive data for a next message, or the client device 104 maintains unused pending data for another message in the input data buffer 116. The method then returns to block 504 or to block 506 as described above and the client device waits to receive a new event.

If the incoming event is not incoming data (i.e., “no” from block 508), then, at block 518, a determination is made as to whether the incoming event is a socket connection closing. If the event is a socket connection closing (i.e., “yes” from block 518), then the input buffer is cleared at block 520. Optionally, at block 522, processing pauses for a designated time duration, and the method returns to block 502. For example, the client device 104 clears the input data buffer 116 if a socket connection of the client device is closed. A socket connection may close for a variety of reasons which can include the server device going down, another event in the client device triggering a shutdown, or a transient network failure. If the event is not a socket connection closing (i.e., “no” from block 518), then the method returns to block 504 or to block 506 as described above and the client device waits to receive a new event.

FIG. 6 illustrates various components of an exemplary computing system 600 that can be implemented in a delayed HTTP response system, such as in the exemplary client-server system 100 described with reference to FIG. 1. The computing system 600 includes a computing device 602 which can be implemented as a client and/or server device in any number of embodiments with numerous other general purpose or special purpose computing system environments or configurations. Examples of well known computing systems, environments, and/or configurations that may be implemented in the exemplary computing system 600 include, but are not limited to, personal computers, hand-held or laptop devices, multiprocessor systems, microprocessor-based systems, set-top boxes, programmable consumer electronics, network PCs, gaming consoles, distributed computing environments that include any of the above systems or devices, and the like.

The computing device 602 includes one or more media content inputs 604 which may include Internet Protocol (IP) inputs over which streams of media content are received via an IP-based network. The media content inputs 604 may also include tuners that can be tuned to various frequencies or channels to receive television signals when client device 602 is embodied as a set-top box or as a digital video recorder, for example. The computing device 602 also includes one or more processors 606 (e.g., any of microprocessors, controllers, and the like) which process various computer executable instructions to control the operation of computing device 602 and to communicate with other electronic and computing devices.

The computing device 602 can be implemented with one or more memory components 608, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like. The memory components 608 provide data storage mechanisms to store various information and/or data such as received media content, software applications, and any other types of information and data related to operational aspects of computing device 602.

An operating system 610, an HTTP application 612, delayed HTTP response logic 614, and application programs 616 can all be maintained as software applications with non-volatile memory components 608 and executed on processor(s) 606 to implement embodiments of delayed HTTP response. The HTTP application 612 is an example of the client HTTP protocol 108 and the HTTP server application 106 described above with reference to the exemplary client-server system 100 shown in FIG. 1. The delayed HTTP response logic 614 is an example of the client and server delayed HTTP response logic 118 and 126, respectively, as described above with reference to the exemplary client-server system 100 shown in FIG. 1.

Although the HTTP application 612 and the delayed HTTP response logic 614 are each illustrated and described as a single application, each can be implemented as several component applications distributed to each perform one or more functions in the exemplary computing system 600. The HTTP application 612 and the delayed HTTP response logic 614 may also be implemented as an integrated, single application. Further, the HTTP application 612 and/or the delayed HTTP response logic 614 may be implemented on a device other than the computing device 602, where the other device may also be configured for communication with computing device 602 in the computing system 600.

As used herein, the term “logic” (e.g., the delayed HTTP response logic 614 in computing device 602, the client delayed HTTP response logic 118 in client device 104, and the server delayed HTTP response logic 126 in server device 102) can also refer to hardware, firmware, software, or any combination thereof that may be implemented to perform the logical operations associated with the embodiments of delayed HTTP response.

The computing device 602 further includes communication interface(s) 618 and input device interfaces 620 which can be implemented as any one or more of a serial and/or parallel interface, a wireless interface, any type of network interface, and as any other type of communication interface. A wireless interface enables computing device 602 to receive control input commands and other information from an input device, such as from a remote control device or from another infrared (IR), 802.11, Bluetooth, or similar RF input device.

A network interface provides a connection between computing device 602 and a communication network by which other electronic and computing devices can communicate data with computing device 602. Similarly, a serial and/or parallel interface provides a data communication path directly between computing device 602 and the other electronic or computing devices. A modem facilitates computing device 602 communication with the other electronic and computing devices via a conventional telephone line, a DSL connection, cable, and/or other type of connection. Although not shown, computing device 602 may also include user and other input devices such as a keyboard, mouse, pointing device, and/or other mechanisms to interact with, and to input information to computing device 602.

Computing device 602 also includes a content processor 622 which can include a video decoder and/or additional processors to receive, process, and decode media content, image content, and display data. Computing device 602 also includes audio and/or video input/outputs 624 that provide audio and/or video to an audio rendering and/or display device 626, or to other devices that process, display, and/or otherwise render audio, video, and display data. Video signals and audio signals can be communicated from computing device 602 to the display device 626 via an RF (radio frequency) link, S-video link, composite video link, component video link, analog audio connection, or other similar communication links.

Although shown separately, some of the components of computing device 602 may be implemented in an application specific integrated circuit (ASIC). Additionally, a system bus (not shown) typically connects the various components within computing device 602. A system bus can be implemented as one or more of any of several types of bus structures, including a memory bus or memory controller, a peripheral bus, an accelerated graphics port, or a local bus using any of a variety of bus architectures.

FIG. 7 illustrates various components of an exemplary broadcast content delivery system 700 which includes a content provider 702, one or more Web (e.g., World Wide Web) server(s) 704, and any number of client devices 706(1-N). A client device 706 receives broadcast content, on-demand content, configuration information, electronic program guide data, on-screen display graphic data, and the like from content provider 702 via a broadcast network 708. The broadcast network 708 can include in-band carousel communication, out-of-band carousel communication, and a two-way communication link 710.

A user can interact with a client device 706 to select a program channel to render a particular program, request a video on-demand movie, respond to a video-phone call, browse program channels, movie listings, the Web, and the like. A user can also interact with the client device 706 to interface with a software application, an e-commerce application, network with others, participate in an on-line game, and any number of other different types of tasks that a user can manage via a client device 706.

The content provider 702 can be implemented as a content provider in a television-based content distribution system, for example, that includes a broadcast transmitter 712 to provide broadcast content 714 and other data, as well as program guide data 716, to the multiple client devices 706(1-N). The content provider 702 can be implemented as a satellite operator, a network television operator, a cable operator, and the like to control distribution of stored content, such as movies, television programs, commercials, music, and other audio, video, and/or image content to the client devices 706(1-N). Additionally, content provider 702 controls distribution of live content (e.g., content that was not previously stored, such as live feeds) and/or content stored at other locations (e.g., the Web server(s) 704 or stored on-demand content 718) to the client devices 706(1-N).

The Web server(s) 704 maintain content which can be requested from a client device 706 as on-demand content, such as a Web page or on-screen display data for an interactive television viewing experience. The content provider 702 can broadcast content to the client devices 706(1-N) that includes Web pages for interactive and Web-based browsing.

In the example broadcast content delivery system 700, content provider 702 implements a carousel file system to broadcast program guide data and on-screen display graphic data via out-of-band carousel communication, and to broadcast content via in-band carousel communication to the client devices 706(1-N). Although not shown specifically, broadcast network 708 can be implemented as any data communication medium, Internet protocol (IP) connection, or communication system having any protocol and/or messaging format.

Further, the broadcast network 708 can be represented or otherwise implemented as a combination of two or more networks, and may also include wired or wireless transmission media using any broadcast format or broadcast protocol. For example, the broadcast network 708 can be implemented as a local area network (LAN), a wide area network (WAN), a public network such as the Internet, and/or any combination thereof. Communication between devices in the exemplary broadcast content delivery system 700 can also be facilitated via a cable network, radio frequency signal, over-air broadcast, satellite transmission, microwave, and the like.

In this example, a client device 706 may be implemented with any number and combination of differing components as further described below with reference to the exemplary computing device 602 shown in FIG. 6. The client devices 706(1-N) can be implemented in any number of embodiments, such as a set-top box, a digital video recorder (DVR) and playback system, a personal video recorder (PVR) and playback system, an appliance device, and as any other type of client device that may be implemented in a television-based entertainment and information system.

Each client device 706(1-N) is coupled to a television or other respective display device 720(1-N) for presenting the content received by the client device (e.g., audio data, video data, and image data), as well as a graphical user interface. A particular client device 706 can be coupled to any number of display devices 720 that can be implemented to display or otherwise render content. Similarly, any number of client devices 706 can be coupled to a single display device 720.

Although embodiments of delayed HTTP response have been described in language specific to structural features and/or methods, it is to be understood that the subject of the appended claims is not necessarily limited to the specific features or methods described. Rather, the specific features and methods are disclosed as exemplary implementations of delayed HTTP response.

1. A server device, comprising:
an HTTP server application configured to:
receive a request for a data connection from a client device;
open the data connection to establish an HTTP communication link to the client device;
receive an HTTP request from the client device;
a server application configured to generate an HTTP response that includes a message for the client device which the server device can communicate to the client device via the HTTP communication link when the message becomes available; and
delayed response logic configured to maintain the data connection to the client device after the message is communicated such that the server device can communicate additional messages to the client device via the HTTP communication link when the additional messages become available and while the HTTP communication link is maintained open.

2. A server device as recited in claim 1, wherein the HTTP server application is further configured to receive the request for the data connection as a request for a TCP connection.

3. A server device as recited in claim 1, wherein the HTTP communication link is maintained open through a firewall of the client device.

4. A server device as recited in claim 1, wherein the HTTP communication link is maintained open through a firewall interposed between the client device and the server device.

5. A server device as recited in claim 1, wherein the server device controls when an additional message is communicated to the client device via the open HTTP communication link.

6. A server device as recited in claim 1, wherein an additional message is initiated by the server device for communication to the client device via the open HTTP communication link.

7. A server device as recited in claim 1, wherein an additional message can be communicated to the client device via the open HTTP communication link without being specifically requested by the client device.

8. A server device as recited in claim 1, wherein the delayed response logic does not wait to receive a second HTTP request from the client device before an additional message is communicated to the client device via the open HTTP communication link.

9. A server device as recited in claim 1, wherein the delayed response logic is further configured to maintain a second HTTP request from the client device as pending until an additional message becomes available and is communicated to the client device via the open HTTP communication link.

10. A server device as recited in claim 1, wherein the delayed response logic does not communicate an indication to the client device that a response to the HTTP request is complete.

11. A server device as recited in claim 1, wherein the delayed response logic does not communicate an indication to the client device that a response to the HTTP request is complete after the message is communicated in its entirety to the client device.

12. A server device as recited in claim 1, wherein the delayed response logic is further configured to control that the data connection is not closed such that the HTTP communication link is maintained open for communication.

13. A server device as recited in claim 1, wherein the delayed response logic is further configured to:
maintain a socket connection list of identifiers that each identify a data connection to a different client device; and
add an identifier of the data connection for the client device to the socket connection list.

14. A server device as recited in claim 1, wherein the delayed response logic is further configured to:
maintain a socket connection list of identifiers that each identify a data connection to a different client device;
add an identifier of the data connection for the client device to the socket connection list; and
remove the identifier of the data connection for the client device from the socket connection list when the data connection is closed.

15. A client device, comprising:
client-side HTTP protocol configured to establish an HTTP communication link to a server device;
a client application configured to communicate an HTTP request to the server device, and receive a message from the server device via the HTTP communication link when the message becomes available at the server device; and
delayed response logic configured to maintain the HTTP communication link to the server device after the message is received such that the client device can receive additional messages from the server device via the HTTP communication link when the additional messages become available and while the HTTP communication link is maintained open.

16. A client device as recited in claim 15, wherein the HTTP communication link is maintained open through a firewall of the client device.

17. A client device as recited in claim 15, wherein the HTTP communication link is maintained open through a firewall interposed between the client device and the server device.

18. A client device as recited in claim 15, wherein an additional message can be received from the server device without being specifically requested by the client application.

19. A client device as recited in claim 15, wherein the delayed response logic is further configured to control that the HTTP communication link is maintained open for communication.

20. A client device as recited in claim 15, wherein the delayed response logic does not receive an indication from the server device that a response to the HTTP request is complete after the message is received in its entirety from the server device.

21. A television-based system, comprising:
an HTTP client-server system configured to establish an HTTP communication link between a television-based client device and a content server; and
delayed response logic configured to maintain the HTTP communication link open between the television-based client device and the content server for communication such that the content server can communicate a message response to an HTTP request from the television-based client device when the message becomes available at the content server, and without an indication to the television-based client device that the message response to the HTTP request is complete after the message is returned to the television-based client device.

22. A television-based system as recited in claim 21, wherein the HTTP communication link is maintained open through a firewall of the television-based client device.

23. A television-based system as recited in claim 21, wherein the HTTP communication link is maintained open through a firewall interposed between the television-based client device and the content server.

24. A television-based system as recited in claim 21, wherein the content server controls when the message is communicated to the television-based client device via the open HTTP communication link.

25. A television-based system as recited in claim 21, wherein the content server can initiate and communicate an additional message to the television-based client device via the open HTTP communication link.

26. A television-based system as recited in claim 21, wherein the content server can initiate and communicate an additional message to the television-based client device via the open HTTP communication link without the additional message being specifically requested by the television-based client device.

27. A television-based system as recited in claim 21, wherein the delayed response logic does not wait to receive an additional HTTP request from the television-based client device before an additional message is communicated to the television-based client device via the open HTTP communication link.

28. A television-based system as recited in claim 21, wherein the delayed response logic is further configured to maintain an additional HTTP request from the television-based client device as pending until an additional message becomes available and is communicated to the television-based client device via the open HTTP communication link.

29. A method, comprising:
receiving a request for a data connection from a client device;
opening the data connection to establish an HTTP communication link to the client device;
receiving an HTTP request from the client device;
communicating a message to the client device via the HTTP communication link when the message becomes available;
maintaining the HTTP communication link open for communication after the message is communicated to the client device; and
communicating additional messages to the client device via the open HTTP communication link when the additional messages become available.

30. A method as recited in claim 29, wherein receiving the request for the data connection includes receiving the request for a TCP connection.

31. A method as recited in claim 29, wherein maintaining the HTTP communication link includes maintaining the HTTP communication link open through a firewall of the client device.

32. A method as recited in claim 29, further comprising initiating the communicating of the message to the client device without receiving a second HTTP request from the client device.

33. A method as recited in claim 29, further comprising maintaining a second HTTP request from the client device as pending until an additional message becomes available and is communicated to the client device via the open HTTP communication link.

34. A method as recited in claim 29, further comprising maintaining the data connection by not communicating an indication to the client device that an HTTP response to the HTTP request is complete.

35. A method as recited in claim 29, further comprising maintaining the data connection by not communicating an indication to the client device that an HTTP response to the HTTP request is complete after the message is communicated in its entirety to the client device.

36. A method as recited in claim 29, further comprising:
maintaining a socket connection list of identifiers that each identify a data connection to a different client device; and
adding an identifier of the data connection for the client device to the socket connection list.

37. A method as recited in claim 29, further comprising:
maintaining a socket connection list of identifiers that each identify a data connection to a different client device;
adding an identifier of the data connection for the client device to the socket connection list; and
removing the identifier of the data connection for the client device from the socket connection list when the data connection is closed.

38. One or more computer readable media comprising computer executable instructions that, when direct a computing device to perform the method as recited in claim 29.

39. One or more computer readable media comprising computer executable instructions that, when executed, direct a television-based content sever to perform the method as recited in claim 29.

40. A method, comprising:
establishing an HTTP communication link to a server device;
communicating an HTTP request to the server device;
receiving a message from the server device via the HTTP communication link when the message becomes available at the server device;
maintaining the HTTP communication link open for communication from the server device after the message is received; and
receiving additional messages from the server device via the HTTP communication link when the additional messages become available and while the HTTP communication link is maintained open.

41. A method as recited in claim 40, wherein maintaining the HTTP communication link includes maintaining the HTTP communication link open through a firewall.

42. A method as recited in claim 40, wherein an additional message received from the server device is not specifically requested.

43. A method as recited in claim 40, wherein an additional message is received from the server device without communicating an additional HTTP request to the server device.

44. A method as recited in claim 40, wherein the message is received from the server device without having received an indication that a response to the HTTP request is complete.

45. One or more computer readable media comprising computer executable instructions that, when executed, direct a computing device to perform the method as recited in claim 40.

46. One or more computer readable media comprising computer executable instructions that, when executed, direct a television-based client device to perform the method as recited in claim 40.

47. One or more computer readable media comprising computer executable instructions that, when executed, direct a server device to:
receive a request for a data connection from a client device;
open a data connection to establish an HTTP communication link to the client device;
receive an HTTP request from the client device;
communicate a message as a first HTTP response to the client device via the HTTP communication link when the message becomes available;
maintain the HTTP communication link open for communication after the message is communicated to the client device; and
communicate an additional message as a second HTTP response to the client device via the open HTTP communication link through a firewall when the additional message becomes available.

48. One or more computer readable media as recited in claim 47, further comprising computer executable instructions that, when executed, direct the server device to control when to communicate the additional message to the client device without having received a second HTTP request from the client device.

49. One or more computer readable media as recited in claim 47, further comprising computer executable instructions that, when executed, direct the server device to maintain the data connection by not communicating an indication to the client device that a response to the HTTP request is complete.

50. One or more computer readable media comprising computer executable instructions that, when executed, direct a client device to:
establish an HTTP communication link to a server device;
communicate an HTTP request to the server device;
receive a first message from the server device via the HTTP communication link when the first message becomes available at the server device;
maintain the HTTP communication link open for communication from the server device after the first message is received; and
receive a second message from the server device via the HTTP communication link when the second message becomes available and while the HTTP communication link is maintained open through a firewall.

51. One or more computer readable media as recited in claim 50, further comprising computer executable instructions that, when executed, direct the client device to receive the second message from the server device without having made an additional request for the second message from the server device.

52. One or more computer readable media as recited in claim 50, further comprising computer executable instructions that, when executed, direct the client device to receive the second message from the server device without having communicated an additional HTTP request to the server device.

53. A computing device, comprising:
means for receiving a request for a data connection from a client device;
means for opening the data connection to establish an HTTP communication link to the client device;
means for receiving an HTTP request from the client device;
means for maintaining the data connection to the client device after returning a message to the client device via the HTTP communication link; and
means for communicating additional messages to the client device via the HTTP communication link when the additional messages become available.

54. A computing device as recited in claim 53, wherein the means for maintaining the data connection includes means for maintaining the HTTP communication link open through a firewall.

55. A computing device as recited in claim 53, further comprising means for controlling communication of an additional message to the client device without receiving a second HTTP request for the additional message.

56. A computing device, comprising:
means for establishing an HTTP communication link to a server device;
means for communicating an HTTP request to the server device;
means for maintaining the HTTP communication link to the server device after a message is received from the server device via the HTTP communication link; and
means for receiving additional messages from the server device via the open HTTP communication link when the additional messages become available at the server device.

57. A computing device as recited in claim 56, wherein the means for maintaining the HTTP communication link includes means for maintaining the HTTP communication link open through a firewall.

58. A computing device as recited in claim 56, wherein the means for receiving the additional messages includes means for receiving an additional message without having made an additional request for the additional message from the server device.
